(19) United States
(12) Patent Application Publication
(10) Pub. No.: US 2018/0107332 A1
(43) Pub. Date: Apr. 19, 2018

(54) ELECTRONIC DEVICE AND TOUCH CONTROL METHOD THEREOF

(71) Applicant: Chiun Mai Communication Systems, Inc., New Taipei (TW)

(72) Inventors: CHIH-MIN CHAN, New Taipei (TW); SUNG-CHIEH CHANG, New Taipei (TW)

(21) Appl. No.: 15/786,761

(22) Filed: Oct. 18, 2017

(30) Foreign Application Priority Data
Oct. 19, 2016 (CN) 201610913649.1

(51) Int. Cl. G06F 3/041; G06K 9/00

(52) U.S. Cl. CPC G06F 3/0416; G06F 3/0414; G06K 9/00006; G06F 3/0412

(57) ABSTRACT

An electronic device with touchscreen control includes a display, a touch sensor, and a processor. The display displays applications and files. The touch sensor receives an input operation from a user and detects an operating mode therein. The operating mode includes operation parameters of the input operations or combinations thereof. The operation parameters include at least one of a biometric pattern characteristic, a pressure characteristic, and a region characteristic. The processor receives the operating mode detected by the touch sensor and compares the detected operating mode to operating modes stored in the electronic device to determine, whether the detected operating mode matches any stored operating mode, and if it does, the processor activates an application or a file corresponding to the detected operating mode. A touch control method of the electronic device is also provided.

### FIELD

The subject matter herein generally relates to an electronic device and a touch control method of the electronic device.

### BACKGROUND

Electronic devices, such as mobile phones, tablet computers, include a touch display for displaying videos, pictures, surfing internet, playing video games, and control objects displayed thereon. Traditionally, applications are triggered by the icons corresponding to the applications being clicked or double clicked after the electronic device is unlocked. However, when the electronic device is loading too many applications, many icons become set as frequently used icons. In this case, searching for a target icon can be inconvenient, which may decrease a user experience.

### BRIEF DESCRIPTION OF THE DRAWINGS

Many aspects of the disclosure can be better understood with reference to the second figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one exemplary embodiment of an electronic device.

FIG. 2 is a diagram of one exemplary embodiment of the electronic device showing divided zones of the display.

FIGS. 3A-3C is a diagram of one exemplary embodiment of the electronic device showing the activation of applications by an operating mode of a combination of characteristics of different fingerprints, pressures, and regions.

FIGS. 4A-4C is a diagram of one exemplary embodiment of the electronic device showing the activation of applications by an operating mode of detecting multiple different biometric pattern characteristics and corresponding input orders.

FIGS. 5A-5C is a diagram of one exemplary embodiment of the electronic device showing the activation of applications by an operating mode of detecting multiple different pressure characteristics and corresponding input orders.

FIGS. 6A-6B is a diagram of one exemplary embodiment of the electronic device showing the activation of applications by an operating mode of detecting multiple different biometric pattern characteristics combining different pressure characteristics and corresponding input orders.

FIGS. 7A-7B is a diagram of one exemplary embodiment of the electronic device showing the activation of applications by an operating mode of detecting multiple different biometric pattern characteristics combining different pressure characteristics.

FIGS. 8A-8B is a diagram of one exemplary embodiment of the electronic device showing the activation of applications by an operating mode of detecting multiple different biometric pattern characteristics combining different pressure characteristics and corresponding sequential orders.

FIGS. 9A-9C is a diagram of one exemplary embodiment of the electronic device showing the activation of applications by an operating mode of detecting multiple different biometric pattern characteristics.

FIGS. 10A-10C is a diagram of one exemplary embodiment of the electronic device showing the activation of applications by an operating mode of a combination of characteristics of different fingerprints and regions.

FIGS. 11A-11C is a diagram of one exemplary embodiment of the electronic device showing the activation of applications by an operating mode of a combination of characteristics of different pressures and regions.

FIG. 12 is a flow chart of one exemplary embodiment of a touch control method of the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

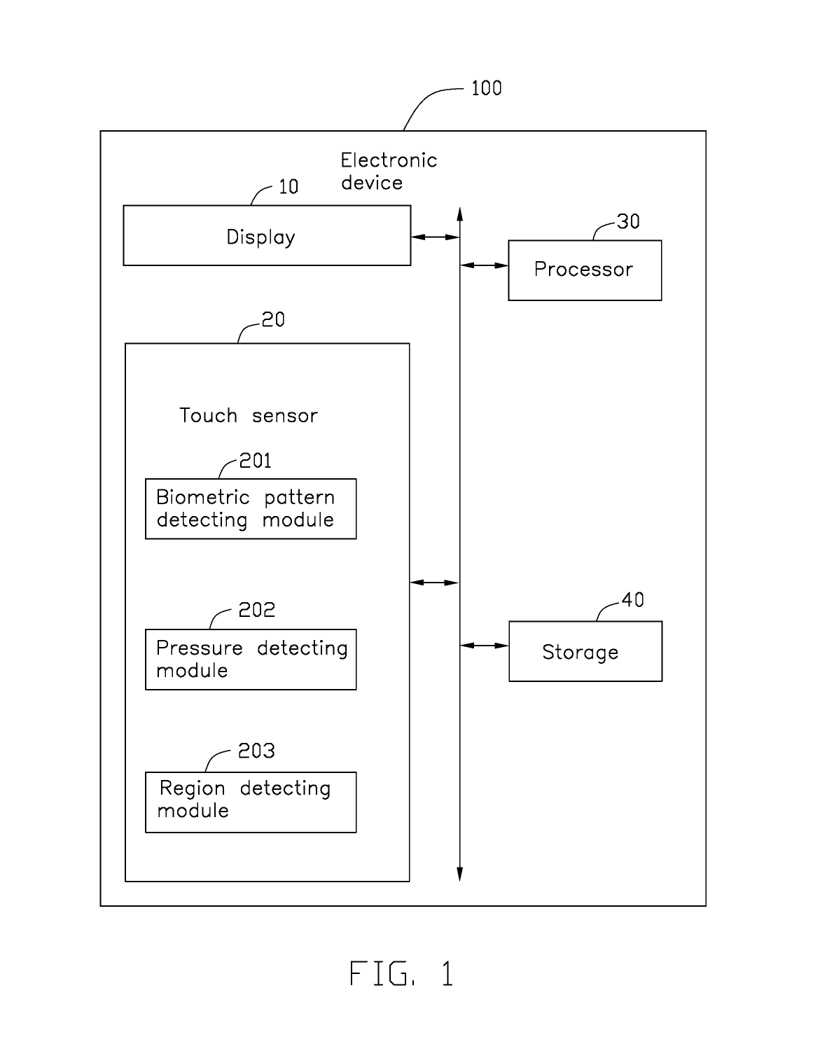

FIG. 1 illustrates one exemplary embodiment of an electronic device 100. The electronic device 100 can be, but is not limited to, a mobile phone, a personal digital assistant, a tablet computer, and a smart watch. The electronic device 100 includes a display 10, a touch sensor 20, a processor 30, and a storage 40. The display 10, the touch sensor 20, the processor 30, and the storage 40 are electrically connected. The display 10 displays graphical user interfaces of applications and/or contents of files. The touch sensor 20 receives user's input operation and detects operation parameters of the input operation. In at least one embodiment, the operation parameters include biometric pattern characteristics, pressure characteristics, and region characteristics. The biometric pattern characteristic may be any biometric pattern information that can be identified. The pressure characteristic is the pressure of the input operation exerted on the touch sensor 20 by the user. The region characteristic indicates the display region receiving the input operation of the user located in the display 10.

In at least one embodiment, the touch sensor 20 includes a biometric pattern detecting module 201, a pressure detecting module 202, and a region detecting module 203. The biometric pattern detecting module 201 detects the biometric pattern characteristics of input operations of a user. The biometric pattern characteristics may include fingerprint(s), toe print(s), palm print(s), the shape of at least one hand and/or the shape of at least one foot. The fingerprint may be human fingerprint or fingerprint of an animal such as ape, orangutan, or koala. The palm print may also be from human or animal.

In general, the word “module,” as used herein, refers to logic embodied in hardware or firmware, or to a collection of software instructions, written in a programming language, such as, Java, C, or Assembly. One or more software instructions in the modules may be embedded in firmware, such as erasable-programmable read-only memory (EPROM). The modules described herein may be implemented as either software and/or hardware modules and may be stored in any type of computer-readable medium or other storage device. Some non-limiting examples of non-transitory computer-readable medium include CDs, DVDs, BLU-RAY, flash memory, and hard disk drives.

The pressure detecting module 202 detects the pressure characteristic of an input operation of the user. The pressure characteristic can be quantified as a high pressure, a medium pressure, a low pressure, or no pressure. The pressure characteristic is not limited to the aforesaid four levels, and can be extended to more levels. In at least one embodiment, the electronic device 100 may indicate by reaction the pressure characteristic to indicate the level the input operation reaches. When the pressure characteristic level is higher, a vibration pressure of the electronic device 100 is greater and when the pressure characteristic is level lower, the vibration pressure of the electronic device 100 is smaller. In at least one embodiment, the pressure characteristic can be presented by characters and graphic patterns displayed on the display 10. For instance, the amount of pressure characteristic can be presented by a bar graph or other graphical gauge displayed on the display 10.

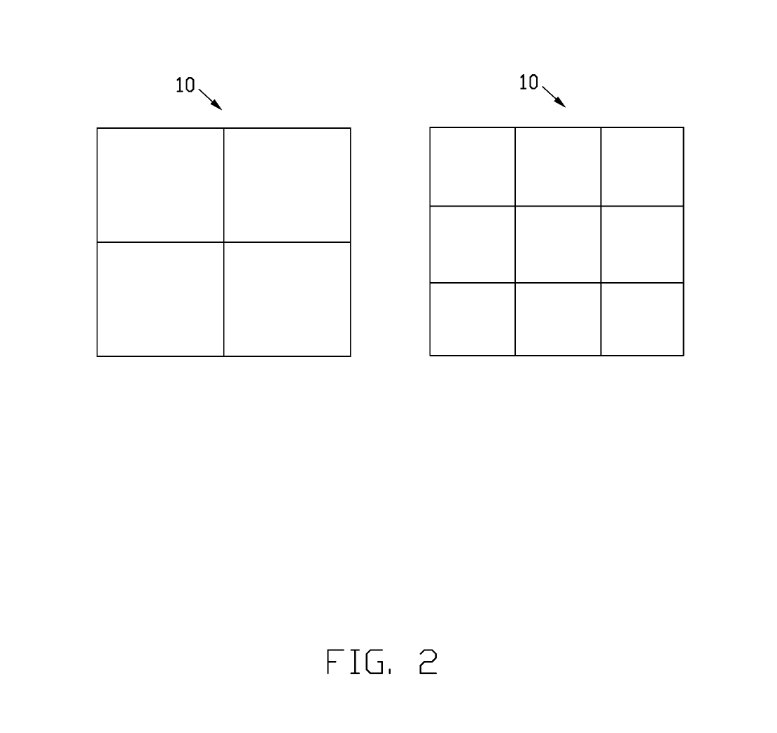

In at least one embodiment, the region detecting module 203 detects the region of the display 10 which receives the input operation of the user. The display 10 can be divided into multiple regions, such as four regions or nine regions (shown in FIG. 2). For instance, when the display 10 is divided into four regions, the region detecting module 203 detects which of an upper left region, an upper right region, a lower left region, or a lower right region receives the input operation.

The processor 30 activates applications or files according to an operating mode formed by different combinations of operation parameters. The operating mode may include the operation parameters, at least one combination of the operation parameters, a combination of the operation parameters and a time sequence of the operation parameters, and combinations of the operation parameters and a time sequence of the combinations. The touch sensor 20 transmits the detected operating mode to the processor 30.

The storage 40 stores the operating modes and corresponding relationships of the operating modes and applications and files. When storage 40 stores an operating mode that is corresponding to the operating mode receiving by the processor 30, the processor 30 activates an application or file corresponding to the operating mode. The application activated by the processor 30 can display an application interface on the display 10. When storage 40 does not store the operating mode that is corresponding to the operating mode receiving by the processor 30, the processor 30 can output a reminder that no matching application or file is found.

In at least one embodiment, the operating modes can be stored in the storage 40, the processor 30 may confirm a current receiving operating mode according to the operating modes stored in the storage 40. Operation parameters of the stored operating modes may require a time sequence. The stored operating modes may include the operation parameters and the related time sequences, or include at least one combination of the operation parameters and the time sequences of the at least one combination of the operation parameters. Alternatively, the operation parameters of the stored operating modes may not require time sequences.

The processor 30 can be a single chip microcomputer or other micro integrated circuits. The storage 40 can be a memory of the electronic device 100 or an external storage device, such as a Smart Media Card, a Secure Digital Card, or a Random-Access Memory (RAM), connected to the electronic device 100.

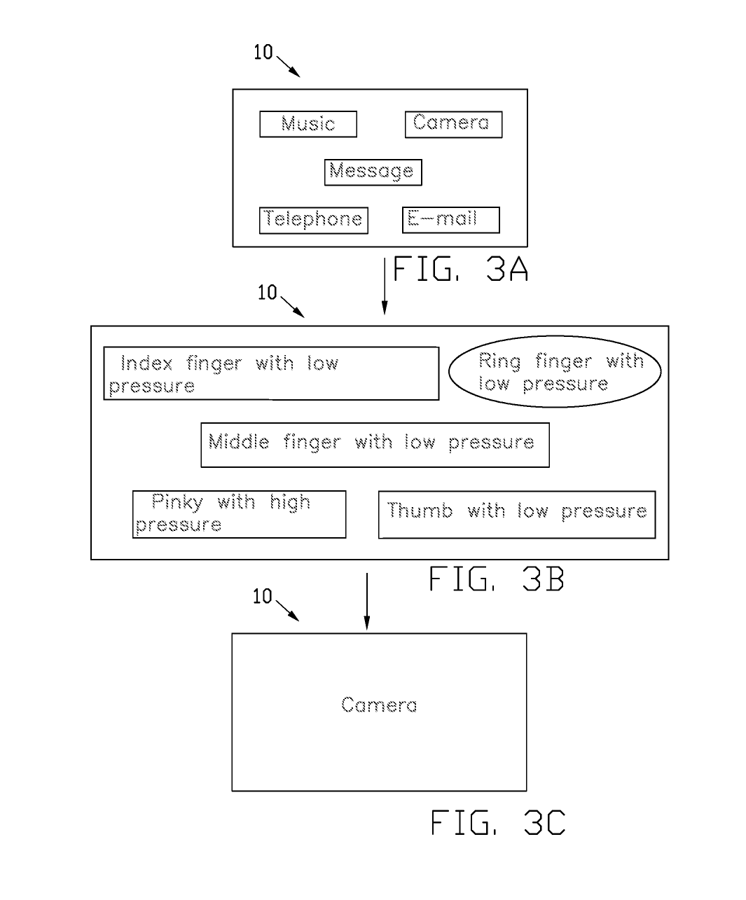

Referring to FIGS. 3 to 11, a user may store different operating modes and corresponding applications and files to the storage 40 by user definition, which may quickly and conveniently activate the corresponding applications and files.

FIGS. 3A-3C illustrate activating of applications by an operating mode of a combination of single biometric pattern characteristic, single pressure characteristic, and single region characteristic. Referring to FIG. 3A, the display 10 is divided into five regions that correspond to five applications. An upper left region corresponds to a music application, an upper right region corresponds to a camera application, a middle region corresponds to a message application, a lower left region corresponds to a telephone application, and a lower right region corresponds to an e-mail application. The storage 40 stores operating modes corresponding to the five applications, as shown in FIG. 3B. The music application corresponds to an operating mode of an index finger touching the upper left region with low pressure. The camera application corresponds to an operating mode of a ring finger touching the upper right region with low pressure. The message application corresponds to an operating mode of a middle finger touching the middle region with low pressure. The telephone application corresponds to an operating mode of a pinky (little finger) touching the lower left region with low pressure. The e-mail application corresponds to an operating mode of a thumb touching the lower right region with low pressure. In at least one embodiment, the operating modes correspond to the applications are stored in the storage 40, the storage 40 also stores the fingerprint of each finger of the user.

When a user touches the upper right region of the display 10 with an operation parameter of the ring finger and low pressure, the region detecting module 203 detects a region characteristic (the upper right region) and transmits to the processor 30. The biometric pattern detecting module 201 detects a biometric pattern characteristic (the ring finger fingerprint) and transmits accordingly to the processor 30. The pressure detecting module 202 detects a pressure characteristic (the low pressure) and transmits same to the processor 30. The processor 30 compares the received operation parameter (ring finger fingerprint and low pressure) and includes the region characteristic (the upper right region) to the stored operating mode in the storage 40. Upon a matching comparison, the camera application corresponding to the operating mode, as shown in FIG. 3C, is activated. In other situations, when the regions of the display 10 receive incorrect operating modes, the applications corresponding to the regions cannot be activated. For instance, when user touches the upper right region of the display 10 with an operation parameter of the index finger and low pressure, the biometric pattern detecting module 201 detects an index finger fingerprint which does not match the stored ring finger fingerprint, the camera application is not activated. Similarly, when a user touches the upper right region of the display 10 with an operation parameter of the ring finger and high pressure, the pressure detecting module 202 detects a high pressure characteristic which does not match the stored low pressure, this causes the camera application is not activated.

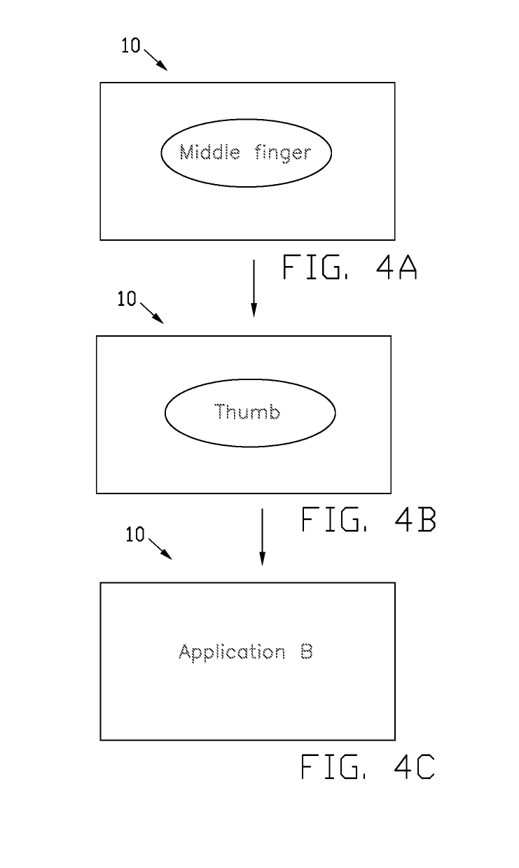

FIGS. 4A-4C illustrate activating of applications by an operating mode of detecting multiple different biometric pattern characteristics and corresponding input orders. Referring to FIG. 4A, firstly a touch with the middle finger of the user is received at any region of the display 10. Referring to FIG. 4B, secondly a touch with the thumb of the user is received at any region of the display 10. The biometric pattern detecting module 201 sequentially detects biometric pattern characteristics of the middle finger fingerprint and the thumb fingerprint, and transmits the operating mode corresponding to the middle finger fingerprint and the thumb fingerprint to the processor 30. The processor 30 compares the received operating mode to the stored operating modes in the storage 40 to determine whether there is a match. When the storage 40 is storing an application B corresponding to an operating mode of detecting a middle finger fingerprint first and a thumb fingerprint second the received operating mode is determined as matching the stored operating modes in the storage 40, and the processor 30 activates the application B, as shown in FIG. 4C.

In at least one embodiment, the touchable regions of the display 10 by the middle finger and the thumb of the user can be the same or not the same. That is, the operating mode includes detecting the middle finger fingerprint first and the thumb fingerprint second in a same region of the display 10 (such as a middle region of the display shown in FIGS. 4A and 4B), or can be detecting the middle finger fingerprint first and the thumb fingerprint second in different regions of the display 10 (not shown).

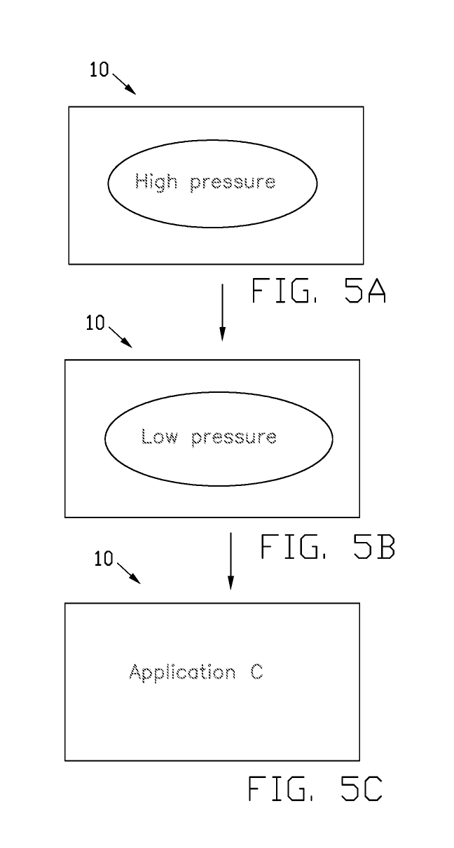

FIGS. 5A-5C illustrate activating of applications by an operating mode of detecting multiple different pressure characteristics and corresponding input orders. Referring to FIG. 5A, firstly, a touch of the user at any region of the display 10 with a high pressure is received. Referring to FIG. 5B, secondly, a touch of the user at any region of the display 10 with a low pressure is received. The pressure detecting module 202 sequentially detects pressure characteristics of the high pressure and the low pressure, and transmits the operating mode corresponding to the high pressure first and the low pressure second to the processor 30. The processor 30 compares the received operating mode to the stored operating modes in the storage 40 to determine whether there are any matches. When the storage 40 is storing an application C corresponding to an operating mode of detecting a high pressure first and a low pressure second, the received operating mode is determined as matching to the stored operating modes in the storage 40, and the processor 30 activates the application C, as shown in FIG. 5C.

In at least one embodiment, the touched regions of the display 10 by the user with the high pressure and the low pressure can be the same or not the same. That is, the operating mode includes detecting the high pressure first and the low pressure second in a same region of the display 10 (such as a middle region of the display shown in FIGS. 5A and 5B), or can detect the high pressure first and the low pressure second in different regions of the display 10 (not shown).

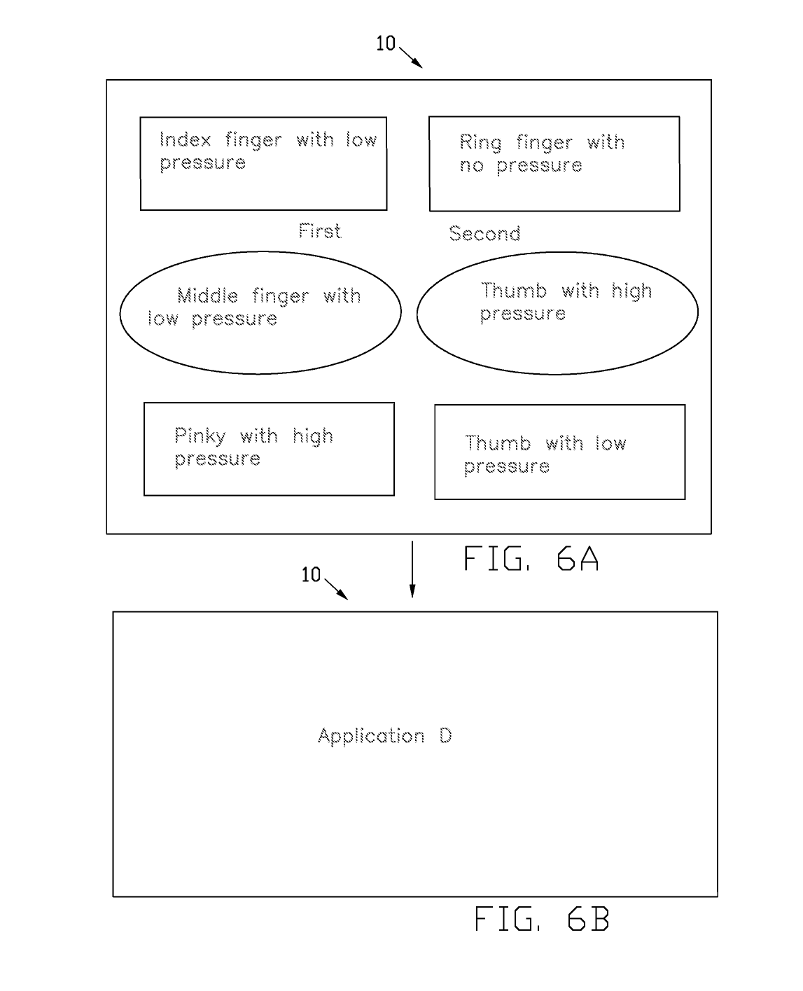

FIGS. 6A-6B illustrate activating of applications by an operating mode of detecting multiple different biometric pattern characteristics with different pressure characteristics and corresponding input orders. Referring to 6A, firstly, a touch with the middle finger of the user is received at any region of the display 10 with low pressure, secondly, a touch with the thumb of the user is received at any region of the display 10 with high pressure. The biometric pattern detecting module 201 sequentially detects biometric pattern characteristics of the middle finger fingerprint first and the thumb fingerprint second, and transmits the detected middle finger fingerprint first and the thumb fingerprint second to the processor 30. The pressure detecting module 202 sequentially detects pressure characteristics of the low pressure and the high pressure, and transmits the detected low pressure first and the high pressure second to the processor 30. By this time, the processor 30 receives the operating mode of middle finger fingerprint with low pressure first and thumb fingerprint with high pressure second. The processor 30 compares the received operating mode to the stored operating modes in the storage 40 to determine whether there are any matches. When the storage 40 is storing an application D corresponding to an operating mode of detecting a middle finger fingerprint with low pressure first and a thumb fingerprint with high pressure second, the received operating mode is determined as matching to the stored operating modes in the storage 40, and the processor 30 activates the application D, as shown in FIG. 6B.

In at least one embodiment, FIGS. 6A-6B also illustrate activating of applications by an operating mode of detecting multiple different biometric pattern characteristics with different region characteristics and corresponding input orders. Referring to 6A, firstly, a touch with the middle finger of the user is received at a first region with low pressure, secondly, a touch with the thumb of the user is received at a second region with high pressure. The first region and the second region are two different stored regions of the display 10. The biometric pattern detecting module 201 sequentially detects biometric pattern characteristics of the middle finger fingerprint first and the thumb fingerprint second, and transmits the detected middle finger fingerprint first and the thumb fingerprint second to the processor 30. The pressure detecting module 202 sequentially detects pressure characteristics of the low pressure and the high pressure, and transmits the detected low pressure first and the high pressure second to the processor 30. The region detecting module 203 sequentially detects region characteristics of the first region first and the second region second, and transmits the the detected first region first and the second region second to the processor 30. By this time, the processor 30 receives the operating mode of middle finger fingerprint with low pressure at the first region first and thumb fingerprint with high pressure at the second region second. The processor 30 compares the received operating mode to the stored operating modes in the storage 40 to determine whether there are any matches. When the storage 40 is storing the application D corresponding to an operating mode of detecting a middle finger fingerprint with low pressure at the first region first and a thumb fingerprint with high pressure at the second region second, the received operating mode is determined as matching to the stored operating modes in the storage 40, and the processor 30 activates the application D, as shown in FIG. 6B.

In other embodiments, referring to FIG. 6A, the touches with the middle finger of the user at any region of the display 10 with low pressure and the thumb of the user at any region of the display 10 with high pressure can be received at the same time. Alternatively, the touch with the middle finger of the user at any region of the display 10 with low pressure can be received first and the touch of the thumb of the user at any region of the display 10 with high pressure received second. Or the touch of the thumb of the user at any region of the display 10 with high pressure can be received first and the touch with the middle finger of the user at any region of the display 10 with low pressure is received second. Or when receiving the touch of the thumb of the user at any region of the display 10 with high pressure, to simultaneously receive the touch with the middle finger of the user at any region of the display 10 with low pressure. That is, the operating mode in FIGS. 6A-6B can be in any time sequences, the first touch can be the thumb or the middle finger, or the time periods of the two fingers touching intersect, or the two fingers can touch at the same time, thus to activate a same corresponding application.

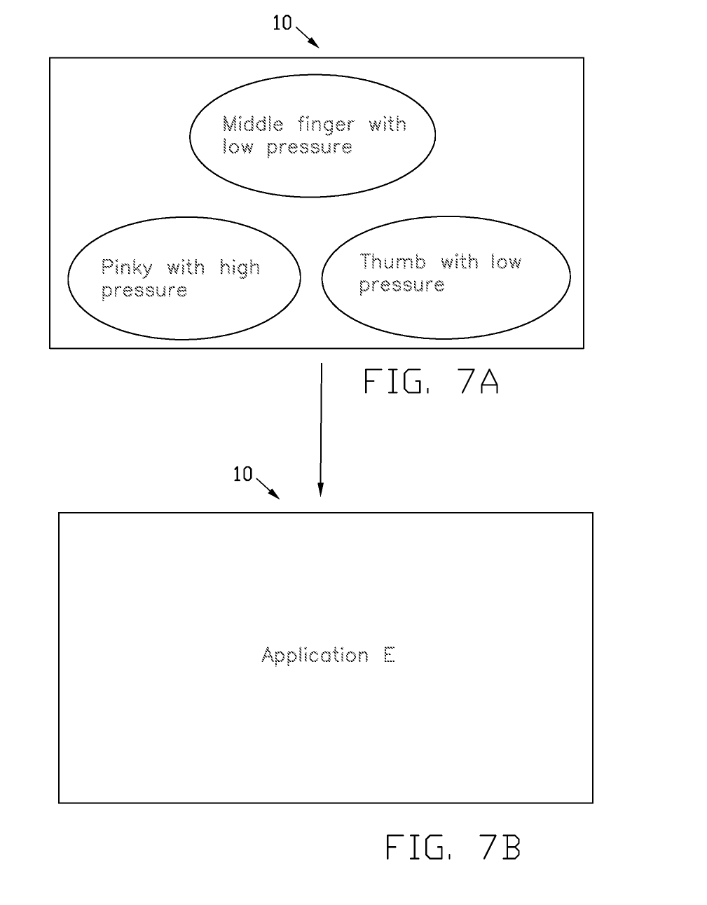

FIGS. 7A-7B illustrate activating of applications by an operating mode of simultaneously detecting multiple different biometric pattern characteristics combining different pressure characteristics. An operating mode of different biometric pattern characteristics combining different pressure characteristics is operated on the display 10. Specifically, referring to FIG. 7A, a touch with the middle finger with low pressure simultaneously with the pinky with high pressure, and with the thumb with low pressure received at any region of the display 10. The biometric pattern detecting module 201 simultaneously detects biometric pattern characteristics of the middle finger, the pinky, and the thumb, and transmits such detected simultaneous the middle finger, the pinky, and the thumb to the processor 30. The pressure detecting module 202 simultaneously detects pressure characteristics of the low pressure, the high pressure, and the low pressure, and transmits such detected simultaneous the low pressure, the high pressure, and the low pressure to the processor 30. By this time, the processor 30 receives the operating mode of simultaneous middle finger fingerprint with low pressure, pinky fingerprint with high pressure, and thumb fingerprint with low pressure. The processor 30 compares the received operating mode to the stored operating modes in the storage 40 to determine whether there are any matches. When the storage 40 is storing an application E corresponding to an operating mode of detecting simultaneous middle finger fingerprint with low pressure, pinky fingerprint with high pressure, and thumb fingerprint with low pressure on the display 10, the received operating mode is determined as matching to the stored operating modes in the storage 40, and the processor 30 activates the application E, as shown in FIG. 7B.

In at least one embodiment, FIGS. 7A-7B also illustrate activating of applications by an operating mode of detecting multiple different biometric pattern characteristics with different pressure characteristics without input orders. User may touch any region of the display 10 with the middle finger with low pressure, pinky with high pressure, and thumb with low pressure without input orders. That is, user may simply touch the display 10 by middle finger with low pressure, by pinky with high pressure, and by thumb with low pressure, and without considering the input or operation orders. In addition, two or three fingers touching the display 10 at the same time may also activate the same corresponding application.

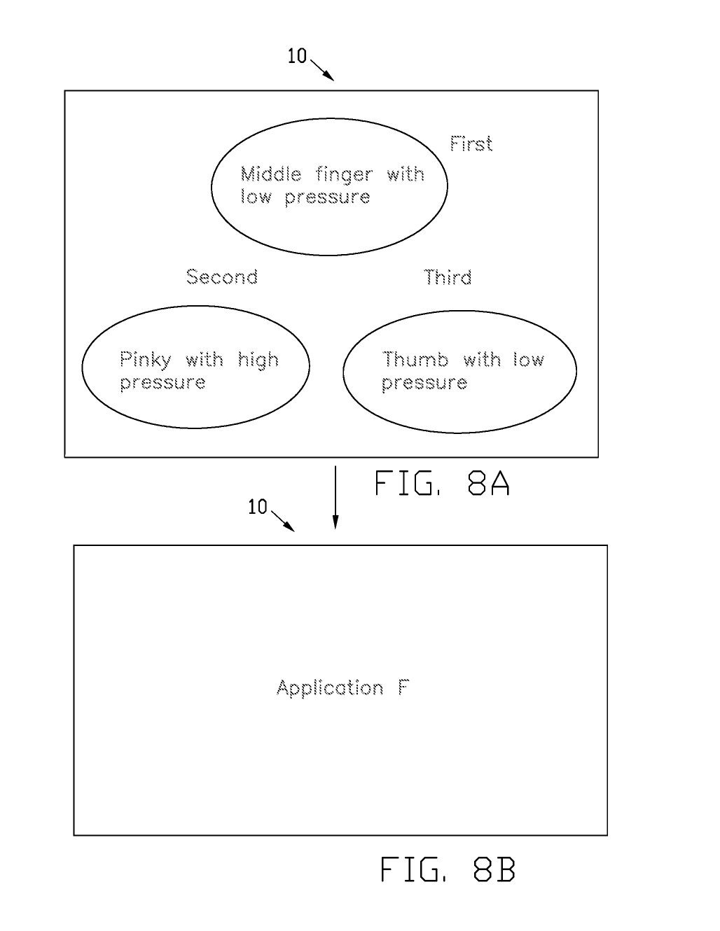

FIGS. 8A-8B illustrate activating of applications by an operating mode of detecting multiple different biometric pattern characteristics combining different pressure characteristics and corresponding sequential orders. The different biometric pattern characteristics combining different pressure characteristics are operated on the display 10 sequentially. Specifically, referring to FIG. 8A, firstly, a touch with the middle finger of the user is received at any region of the display 10 with low pressure, secondly, a touch with the pinky of the user is received at any region of the display 10 with high pressure, and thirdly, a touch with the thumb of the user is received at any region of the display 10 with low pressure. The biometric pattern detecting module 201 sequentially detects biometric pattern characteristics of the middle finger fingerprint first, pinky fingerprint second, and thumb fingerprint third, and transmits the detected middle finger fingerprint first, pinky fingerprint second, and thumb fingerprint third to the processor 30. The pressure detecting module 202 sequentially detects pressure characteristics of the low pressure first, the high pressure second, and the low pressure third, and transmits detection of the low pressure first, the high pressure second, and the low pressure third to the processor 30. By this time, the processor 30 receives the operating mode of middle finger fingerprint with low pressure first, pinky fingerprint with high pressure second, and thumb fingerprint with low pressure third on the display 10. The processor 30 compares the received operating mode to the stored operating modes in the storage 40 to determine whether there are any matches. When the storage 40 is storing an application F corresponding to an operating mode of detecting a middle finger fingerprint with low pressure first, a pinky fingerprint with high pressure second, and a thumb fingerprint with low pressure third, the received operating mode is determined as matching to the stored operating modes in the storage 40, and the processor 30 activates the application F, as shown in FIG. 8B.

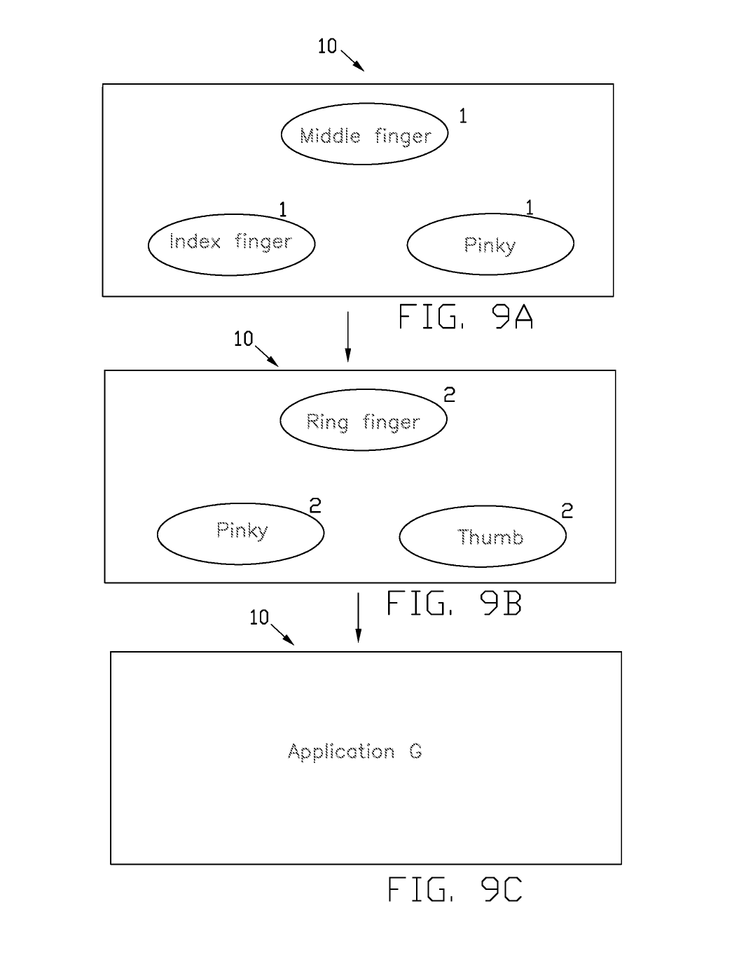

In at least one embodiment, the operating modes further include multistage operating mode, which indicates receiving operation parameters in multiple preset time periods. Each of the preset time periods includes an operation parameter or a combination of the operation parameters of the input operation, and the preset operating modes define a preset time sequence of the multiple preset time periods. Input operations of a later preset time period in the preset time sequence has to be finished later than input operations of the earlier preset time period in the preset time sequence. FIGS. 9A-9C illustrate activating of applications by an operating mode of detecting multiple different biometric pattern characteristics at multiple stages. The operating mode of multistage detecting different biometric pattern characteristics can detect different biometric pattern characteristics in a first preset time period and a second preset time period. For instance, after detecting different biometric pattern characteristics of the user touching at any region of the display 10 in a first preset time period as shown in 9A, numbers “1” are presented beside the biometric pattern characteristics. Then, after detecting different biometric pattern characteristics of the user touching at any region of the display 10 in a second preset time period as shown in 9B, numbers “2” are presented beside the biometric pattern characteristics. The biometric pattern detecting module 201 detects biometric pattern characteristics of the middle finger fingerprint, the index finger fingerprint, and the pinky fingerprint in a first time period, and transmits detected middle finger fingerprint, the index finger fingerprint, and the pinky fingerprint to the processor 30. The biometric pattern detecting module 201 detects biometric pattern characteristics of the ring finger fingerprint, the pinky fingerprint, and the thumb fingerprint in a second time period, and transmits detection of the ring finger fingerprint, the pinky fingerprint, and the thumb fingerprint to the processor 30. By this time, the processor 30 receives the operating mode of the detected middle finger fingerprint, the index finger fingerprint, and the pinky fingerprint in the first time period and the detected ring finger fingerprint, the pinky fingerprint, and the thumb fingerprint in the second time period. The processor 30 compares the received operating mode to the stored operating modes in the storage 40 to determine whether there are any matches. When the storage 40 is storing an application G corresponding to an operating mode of the middle finger fingerprint, the index finger fingerprint, and the pinky fingerprint in the first time period and the ring finger fingerprint, the pinky fingerprint, and the thumb fingerprint in the second time period, the received operating mode is determined as matching to the stored operating modes in the storage 40, and the processor 30 activates the application as shown in FIG. 9C.

In other embodiments, the operation parameters in each preset time period of the operating modes of FIGS. 9A-9B can be unordered. For instance, the touches of the middle finger, the index finger and the pinky can be in any time sequence in the first preset time period, and touching durations of the three fingers can be partly or totally overlapping. The touches of the ring finger, the thumb and the pinky can be in any time sequence in the second preset time period, and touching durations of the three fingers can be partly or totally overlapping.

In at least one embodiment, the operating modes further include multistage detecting different pressure characteristics. For instance, the operating mode of multistage detecting different pressure characteristics can be detecting different pressure characteristics in a first time period and a second time period. The operating modes further include multistage detecting different biometric pattern characteristics combining pressure characteristics. For instance, the operating mode of multistage detecting different pressure characteristics can be detecting different biometric pattern characteristics combining different pressure characteristics in a first time period and a second time period. Furthermore, the operating mode may be multistage detecting different biometric pattern characteristics and their time sequence, multistage detecting different pressure characteristics and their time sequence, or multistage detecting different biometric pattern characteristics combining different pressure characteristics and their time sequence. In addition, the operating modes may further include region characteristics, which is similar to the aforesaid embodiments and is not described in detail here.

In other embodiments, the multistage may include more preset time periods rather than the first preset time period and the second preset time period.

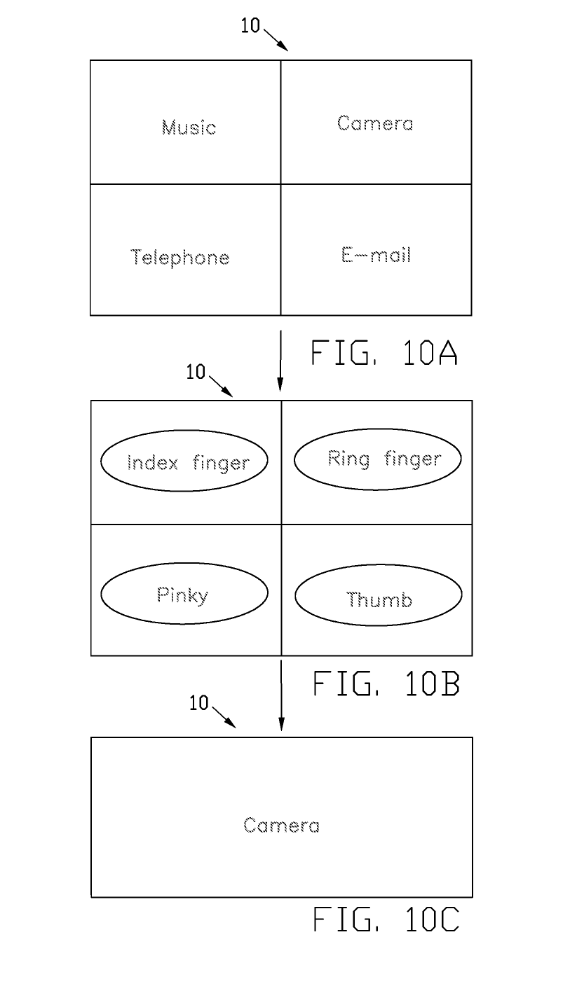

FIGS. 10A-10C illustrate activating applications by an operating mode of a combination of fingerprint characteristics and region characteristics. Referring to FIG. 10A, the display 10 is divided into four regions and includes four different applications in the four regions. In at least one embodiment, an upper left region is corresponding to a music application, an upper right region is corresponding to a camera application, a low left region is corresponding to a telephone application, and a low right region is corresponding to an e-mail application. The storage 40 stores four operating modes corresponding to the four applications, as shown in FIG. 10B. An operating mode corresponding to the music application is touching the upper left region by the index finger, an operating mode corresponding to the camera application is touching the upper right region by the ring finger, an operating mode corresponding to the telephone application is touching the lower left region by the pinky, and an operating mode corresponding to the e-mail application is touching the lower right region by the thumb.

When the user touches the upper right region of the display 10 by the ring finger, the region detecting module 203 detects an upper right region characteristic and transmits to the processor 30. The biometric pattern detecting module 201 detects a ring finger characteristic and transmits to the processor 30. The processor 30 compares the received operation parameters of the ring finger characteristic and the upper right region characteristic to the stored operating modes in the storage 40 to determine whether there are any matches, when there are any matches, the processor 30 activates the camera application corresponding to the matched operating mode, as shown in FIG. 10C.

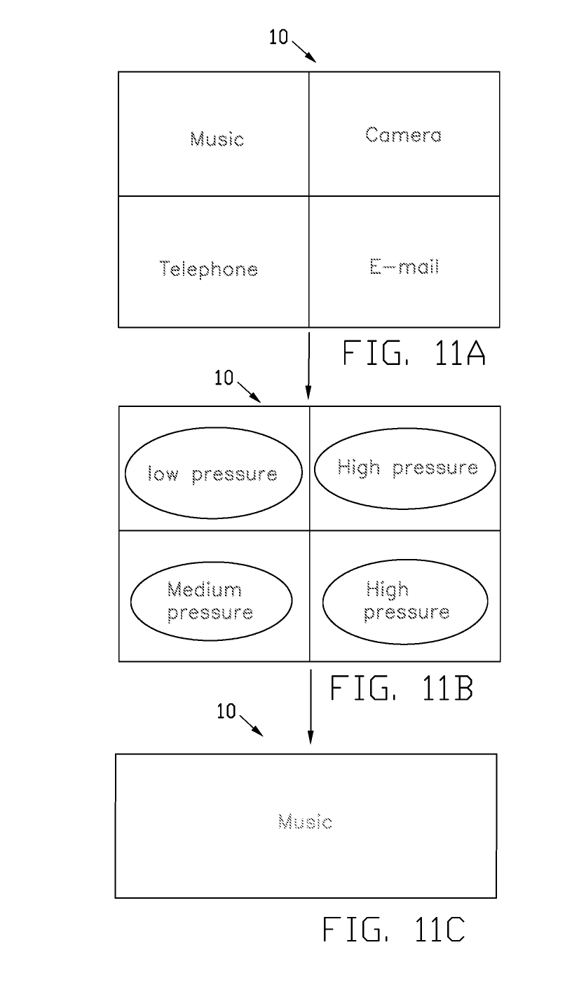

FIGS. 11A-11C illustrate activating applications by an operating mode of a combination of pressure characteristics and region characteristics. Referring to FIG. 11A, display 10 is divided into four regions and includes four different applications in the four regions. In at least one embodiment, an upper left region is corresponding to a music application, an upper right region is corresponding to a camera application, a low left region is corresponding to a telephone application, and a low right region is corresponding to an e-mail application. The storage 40 stores four operating modes corresponding to the four applications, as shown in FIG. 11B. An operating mode corresponding to the music application is touching the upper left region low pressure, an operating mode corresponding to the camera application is touching the upper right region with high pressure, an operating mode corresponding to the telephone application is touching the lower left region with medium pressure, and an operating mode corresponding to the e-mail application is touching the lower right region with high pressure.

When the user touches the upper left region of the display 10 with low pressure, the region detecting module 203 detects an upper left region characteristic and transmits to the processor 30. The pressure detecting module 202 detects a low pressure characteristic and transmits to the processor 30. The processor 30 compares the received operation parameters of the upper left region characteristic and the low pressure characteristic to the stored operating modes in the storage 40 to determine whether there are any matches, when there are any matches, the processor 30 activates the music application corresponding to the matched operating mode, as shown in FIG. 11C.

In at least one embodiment, the display 10 includes a locked mode and an unlocked mode. When the display 10 is in the locked mode, the processor 30 may receive the operating mode from the user without unlocking the display 10 in advance, and then compares the received operating mode to the stored operating modes in the storage 40 to determine whether there are any matches, then the processor 30 may directly unlock the display 10 and activates the corresponding application or file according to the received operating mode when the received operating mode matches one of the stored operating modes.

In at least one embodiment, the display 10 may or may not display icons of the applications or files. The processor 30 may receive operating modes from the user no matter whether or not the display 10 is displaying the icons of the applications or files, and the processor 30 further compares the received operating mode to the stored operating modes in the storage 40 to determine whether there are any matches, then the processor 30 directly activates the corresponding application or file according to the received operating mode the received operating mode matches one of the stored operating modes.

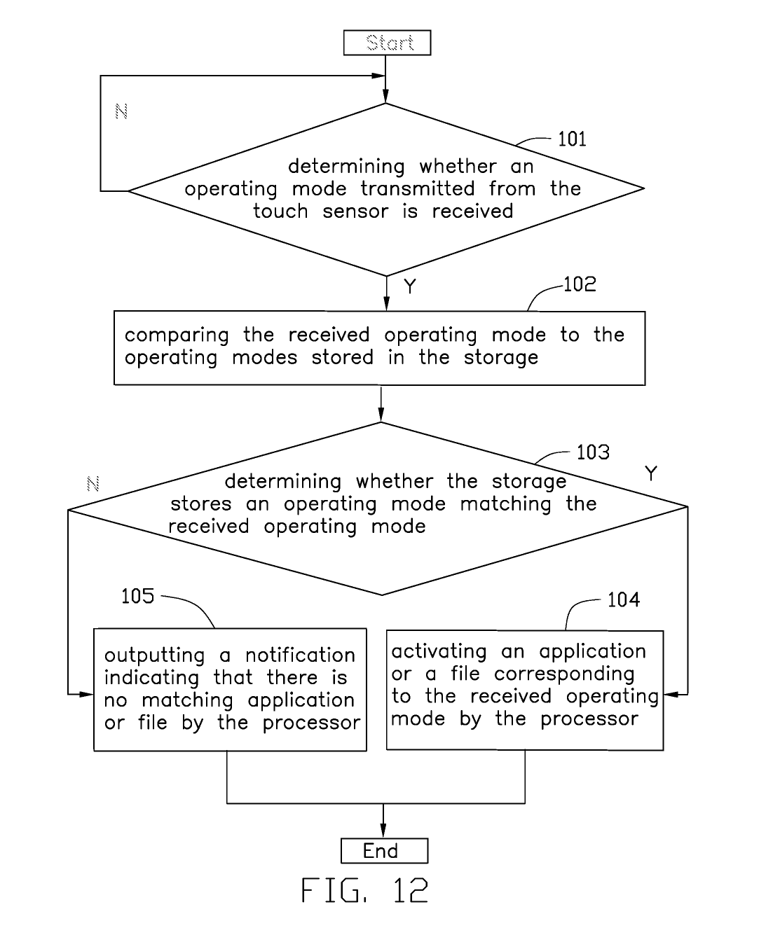

FIG. 12 illustrates a flowchart is presented in accordance with an example embodiment which is being thus illustrated. The example a touch control method of the electronic device 100 described below can be carried out using the configurations illustrated in FIG. 1, for example, and various elements of these figures are referenced in explaining example method. The example touch control method of the electronic device 100 is provided by way of example, as there are a variety of ways to carry out the method. Each block shown in FIG. 12 represents one or more processes, methods or subroutines, carried out in the exemplary method. Furthermore, the illustrated order of blocks is by example only and the order of the blocks can change according to the present disclosure. Additional blocks may be added or fewer blocks may be utilized, without departing from this disclosure. The exemplary method can begin at block 101.

At block 101, determining whether an operating mode transmitted from the touch sensor 20 is received. The operating mode may include the aforementioned operation parameters, at least one combination of the operation parameters, a combination of operation parameters and a time sequence of the operation parameters, or combinations of operation parameters and a time sequence of the combinations of operation parameters. The operation parameters include biometric pattern characteristics, pressure characteristics, and region characteristics. When an operating mode from the touch sensor 20 is received, block 102 is executed; otherwise this block is repeated.

At block 102, comparing the received operating mode to the operating modes stored in the storage 40.

At block 103, determining whether the storage 40 stores an operating mode matching the received operating mode. If there is, a block 104 is executed; otherwise, a block 105 is executed.

At block 104, activating an application or a file corresponding to the received operating mode by the processor 30.

At block 105, outputting a notification indicating that there is no matching application or file by the processor 30.

The user may define operating modes and store in the storage 40 for rapidly activating corresponding applications or files, and the activated applications or files are displayed on the display 10. Therefore, the user may rapidly and directly access the applications or files, which can greatly improve user experience.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure. The embodiments shown and described above are only examples. Many details are often found in the art such as the other features. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An electronic device with touchscreen control, the electronic device comprising:
a display;
a touch sensor receiving an input operation from a user and detecting an operating mode of the input operation, the operating mode comprising operation parameters of the input operation or a combination of operation parameters of the input operation, the operation parameters comprising at least one of a biometric pattern characteristic, a pressure characteristic, and a region characteristic; and
a processor receiving the operating mode detected by the touch sensor and comparing the detected operating mode to operating modes stored in the electronic device, when the detected operating mode matches one of the stored operating modes, activating an application or a file corresponding to the detected operating mode.

2. The electronic device as claimed in claim 1, further comprising a storage, wherein the storage stores the operating modes and corresponding relationships of the operating modes and applications and/or files.

3. The electronic device as claimed in claim 1, wherein the display comprises a locked mode, when the display is in the locked mode, the processor receives the operating mode from the user without unlocking the display in advance and then compares the received operating mode to the stored operating modes, the processor directly unlocks the display and activates the corresponding application or file according to the received operating mode when the received operating mode matches one of the stored operating modes.

4. The electronic device as claimed in claim 1, wherein the processor receives the operating mode inputted by the user when the display is not displaying icons of applications and files, and the processor further compares the received operating mode to the stored operating modes, then the processor activates the corresponding application or file according to the received operating mode when the received operating mode matches one of the stored operating modes.

5. The electronic device as claimed in claim 1, wherein the stored operating modes comprise the operation parameters and a time sequence of the operation parameters, or comprise combinations of the operation parameters and a time sequence of the combinations of the operation parameters.

6. The electronic device as claimed in claim 1, wherein the operation parameters of at least one preset operating mode stored in the electronic device do not require time sequence.

7. The electronic device as claimed in claim 1, wherein a preset operating mode stored in the electronic device comprises multiple preset time periods, each of the preset time periods comprises an operation parameter or a combination of operation parameters, the preset operating mode defines a preset time sequence of the multiple preset time periods, input operations of a later preset time period in the preset time sequence has to be finished later than input operations of an earlier preset time period in the preset time sequence.

8. The electronic device as claimed in claim 1, wherein the biometric pattern characteristic is biometric pattern information that can be identified, the pressure characteristic is a pressure of the input operation exerted on the touch sensor by the user, the region characteristic indicates a display region receiving the input operation of the user located in the display.

9. A touch control method of an electronic device, the touch control method comprising:
receiving an input operation from a user on a display of the electronic device;
detecting an operating mode of the input operation, the operating modes comprising operation parameters of the input operation or a combinations of operation parameters of the input operation, the operation parameters comprising at least one of a biometric pattern characteristic, a pressure characteristic, and a region characteristic; and
comparing the detected operating mode to operating modes stored in the electronic device and activating an application or a file corresponding to the detected operating mode when the detected operating mode matches one of the stored operating modes.

10. The touch control method as claimed in claim 9, further comprising:
storing the operating modes and corresponding relationships of the operating modes and applications and/or files in a storage of the electronic device.

11. The touch control method as claimed in claim 9, further comprising:
receiving the operating mode from the user without unlocking the display of the electronic device in advance when the display is in a locked mode, and then comparing the received operating mode to the stored operating modes; and
directly unlocking the display and activating the corresponding application or file according to the received operating mode when the received operating mode matches one of the stored operating modes.

12. The touch control method as claimed in claim 9, further comprising:
receiving the operating mode inputted by the user when the display of the electronic device is not displaying icons of applications and files;
comparing the received operating mode to the stored operating modes; and
activating the corresponding application or file according to the received operating mode when the received operating mode matches one of the stored operating modes.

13. The touch control method as claimed in claim 9, wherein the stored operating modes comprise the operation parameters and a time sequence of the operation parameters, or comprise the combinations of the operation parameters and a time sequence of the combinations of the operation parameters.

14. The touch control method as claimed in claim 9, wherein the operation parameters of at least one preset operating mode stored in the electronic device do not require time sequence.

15. The touch control method as claimed in claim 9, wherein a preset operating mode stored in the electronic device comprises multiple preset time periods, each of the preset time periods comprises an operation parameter or a combination of operation parameters, the preset operating mode defines a preset time sequence of the multiple preset time periods, input operations of a later preset time period in the preset time sequence has to be finished later than input operations of an earlier preset time period in the preset time sequence.

16. The touch control method as claimed in claim 9, wherein the biometric pattern characteristic is biometric pattern information that can be identified, the pressure characteristic is a pressure of the input operation exerted on the touch sensor by the user, the region characteristic indicates a display region receiving the input operation of the user located in the display of the electronic device.
